(19) United States
(12) Patent Application Publication
(10) Pub. No.: US 2016/0170109 A1
(43) Pub. Date: Jun. 16, 2016

(54) DISPLAY MODULE

(71) Applicants: WISTRON CORP., New Taipei City (TW); INDUSTRIAL TECHNOLOGY RESEARCH INSTITUTE, Hsinchu (TW)

(72) Inventors: Chih-Ming HSU, New Taipei City (TW); Kuo-Hua CHEN, New Taipei City (TW); Pao-Ju HSIEH, Hsinchu City (TW); Mei-Chih PENG, Hsinchu (TW)

(21) Appl. No.: 14/878,946

(22) Filed: Oct. 8, 2015

(30) Foreign Application Priority Data
Dec. 12, 2014 (TW) 103143570
Jun. 15, 2015 (TW) 104119262

(51) Int. Cl. G02B 5/30; G02B 27/28; G02B 1/118

(52) U.S. Cl. CPC G02B 5/3016; G02B 1/118; G02B 27/283

(57) ABSTRACT

A display module includes a display panel and a reflective optical film. The display panel has a display surface. The reflective optical film is disposed on the display surface of the display panel. The reflective optical film includes a cholesteric liquid crystal layer and a first anti-glare layer. The first anti-glare layer is disposed between the display panel and the cholesteric liquid crystal layer.

### CROSS-REFERENCE TO RELATED APPLICATIONS

This non-provisional application claims priority under 35 U.S.C. §119(a) on Patent Application No(s). 104119262 filed in Taiwan, R.O.C. on Jun. 15, 2015 and Patent Application No(s). 103143570 filed in Taiwan, R.O.C. on Dec. 12, 2014, the entire contents of which are hereby incorporated by reference.

### TECHNICAL FIELD

The present disclosure relates to a display module, more particularly to a display module having a reflective optical film.

### BACKGROUND

In recent years, the quality of multimedia entertainment has increased significantly. Display manufacturers develop large-size planar display devices for consumers to have better visual effects. However, when the power of the large-size planar display device is off, the large-size planar display device cannot perform its original functions and is nothing more than a decoration.

Some manufacturers develop planar display devices with mirror functions for providing an additional value when the power of the planar display device is off. In detail, a polarized light mirror material is attached to a display surface of the display device such that the display surface can reflect what happens in front of the display device when the power of the planar display device is off. In addition, the function of displaying images is recovered when the power of the planar display device is on. However, the transmittance of the whole planar display device is reduced and the glare is increased because the reflective type polarized light material may refract, reflect or polarize parts of light emitted from the display device, thereby reducing the display quality of the planar display device. Hence, manufacturers are constantly trying to develop a polarized light mirror that is highly penetrable with a low glare to prevent the polarized light mirror from affecting the original display function of the planar display device.

### SUMMARY

The disclosure provides a display module including a display panel and a reflective optical film. The display panel has a display surface. The reflective optical film is disposed on the display surface of the display panel. The reflective optical film includes a cholesteric liquid crystal layer and a first anti-glare layer. The first anti-glare layer is disposed between the display surface of the display panel and the cholesteric liquid crystal layer.

### BRIEF DESCRIPTION OF THE DRAWINGS

FIG. 1 is a schematic view of a display module according to a first embodiment of the disclosure;

FIG. 2 is a chart of delays (nm) of a first anti-glare layer exposed to a plurality of light beams having different wavelengths (nm) according to the first embodiment of the disclosure;

FIG. 3A is a chart of transmittances (T %) of a reflective optical film exposed to a plurality of light beams having different wavelengths (nm) according to the first embodiment of the disclosure;

FIG. 3B is a chart of reflection rates (R %) of the reflective optical film exposed to the plurality of light beams having different wavelengths (nm) according to the first embodiment of the disclosure;

FIG. 4 is a schematic view of a display module according to a second embodiment of the disclosure;

FIG. 5A is a chart of transmittances (T %) of a reflective optical film exposed to a plurality of light beams having different wavelengths (nm) according to the second embodiment of the disclosure;

FIG. 5B is a chart of reflection rates (R %) of the reflective optical film exposed to the plurality of light beams having different wavelengths (nm) according to the second embodiment of the disclosure;

FIG. 6 is a schematic view of a display module according to a comparative group of the disclosure;

FIG. 7A a chart of transmittances (T %) of a reflective optical film exposed to a plurality of light beams having different wavelengths (nm) according to the comparative group of the disclosure; and

FIG. 7B is a chart of reflection rates (R %) of the reflective optical film exposed to the plurality of light beams having different wavelengths (nm) according to the comparative group of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

Please refer to FIG. 1, which is a schematic view of a display module according to a first embodiment of the disclosure. In the first embodiment, the display module 1 includes a display panel 20 and a reflective optical film 10a. The display panel 20 has a display surface 22. The reflective optical film 10a includes a first anti-glare layer 100 and a cholesteric liquid crystal layer 300. The first anti-glare layer 100 is disposed between the display surface 22 of the display panel 20 and the cholesteric liquid crystal layer 300.

In addition, the reflective optical film 10a further includes a first light transmission adhesive 200. The cholesteric liquid crystal layer 300 is attached to the first anti-glare layer 100 through the first light transmission adhesive 200. The first light transmission adhesive 200 is, for example, an ultraviolet ray optical adhesive, e.g., CHEM-MAT, No. UV298.

The first anti-glare layer 100 is for converting the linear polarized light to circularly polarized light. The first anti-glare layer 100 has a plurality of moth-eye structures or periodically wave-shaped nanostructures disposed thereon. The first anti-glare layer 100 is, for example, a polyethylene terephthalate (PET) having a plurality of conical protrusions (moth-eye structures) which are made of photocurable resin (photopolymer). Each of the conical protrusions has a height of about 200 nm and the diameter of its bottom surface is about 100 nm. In general, reflection of light may occur whenever light travels from a medium with a given refractive index into another medium with a refractive index that is different from the given refractive index, and a boundary between the two mediums is a so-called optical boundary. However, in this embodiment, because the proportion of air and the photopolymer is gradually changing in a direction from the top to the bottom of the conical protrusions (moth-eye structures), the optical boundary does not exist and the reflection of light may not occurs.

In the case that the first anti-glare layer 100 has the periodically wave-shaped nanostructures disposed thereon, a height between the bottom and the top of the nanostructures is in a range between 100 nm and 200 nm. The first anti-glare layer 100 will not reflect light when the wavelength of light divided by the refractivity of the first anti-glare layer 100 equals to a number which is greater than the height between the bottom and the top of the nanostructures.

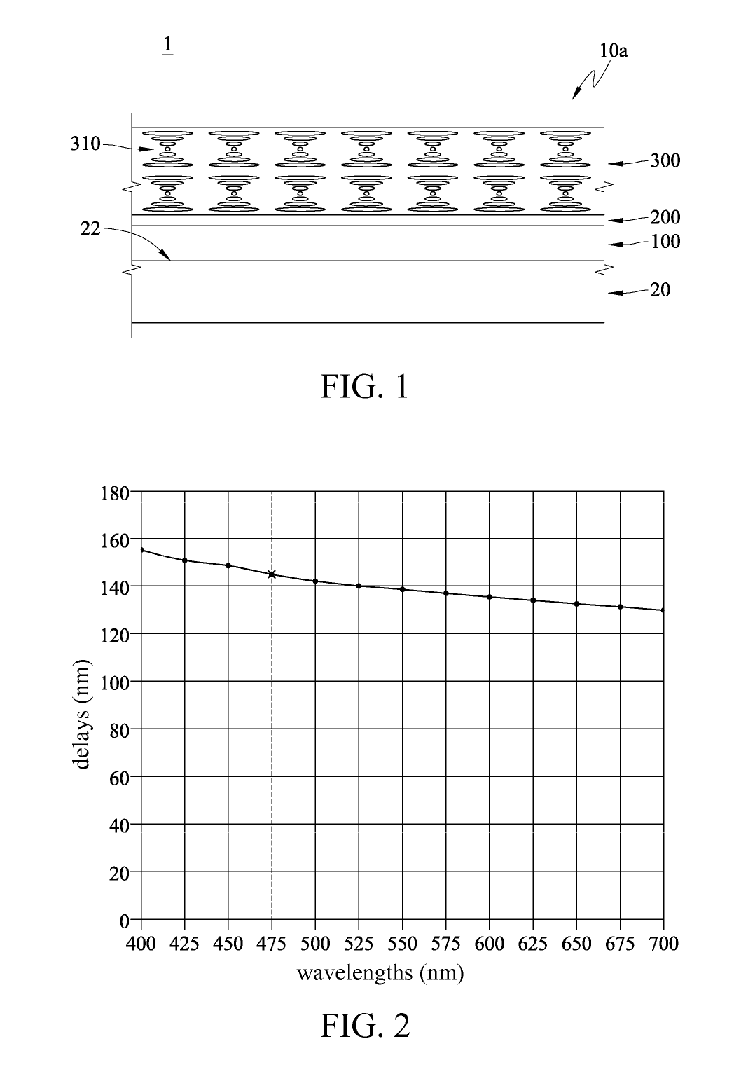

Please refer to FIG. 2, which is a chart of delays (nm) of a first anti-glare layer exposed to a plurality of light beams having different wavelengths (nm) according to the first embodiment of the disclosure. The delays are in a range between 120 nm and 160 nm. The linear polarized light is converted into circularly polarized light by the first anti-glare layer 100.

The cholesteric liquid crystal layer 300 has a plurality of helical liquid crystal molecules 310. The plurality of helical liquid crystal molecules 310 matches with the circularly polarized light. For example, when the helical liquid crystal molecules 310 are dextrorotatory, levorotatory circularly polarized light is able to penetrate through the helical liquid crystal molecules 310, and dextrorotatory circularly polarized light is reflected by the helical liquid crystal molecules 310. When the helical liquid crystal molecules 310 are levorotatory, the dextrorotatory circularly polarized light is able to penetrate through the helical liquid crystal molecules 310, and the levorotatory circularly polarized light is reflected by the helical liquid crystal molecules 310.

The cholesteric liquid crystal layer 300 is, for example, a photo polymerization cholesteric liquid crystal layer. The photo polymerization cholesteric liquid crystal layer has at least one functional group, and the at least one functional group is a small molecule or an oligomer.

The method for producing the aforementioned cholesteric liquid crystal layer 300 will be further described below. In the method for producing the cholesteric liquid crystal layer 300, a first substrate is provided. Then, an orientation film is coated on the first substrate. But the disclosure is not limited to the method for manufacturing the orientation film. In some embodiments, the function of orientation is generated by mechanically brushing and milling the first substrate. Then, a photo polymerization liquid crystal layer is coated on the orientation film. Then, the photo polymerization liquid crystal layer is solidified. For example, the photo polymerization liquid crystal layer is solidified by irradiating ultraviolet ray or radiation. Then, the step of coating a photo polymerization liquid crystal layer on the orientation film and the step of solidifying the photo polymerization liquid crystal layer are repeated until a wavelength of reflection reaches within a predetermined range, e.g. a reflection wavelength in a wavelength range between 400 nm and 700 nm.

For example, a mixture of polymerized Cholesteric Liquid Crystal BASF242 and polymerized Cholesteric Liquid Crystal BASF 756 with a ratio of 95:5 is mixed with Toluene to form a mixed solution which comprises 30 wt % of the mixture of polymerized Cholesteric Liquid Crystal BASF242 and polymerized Cholesteric Liquid Crystal BASF 756. Afterwards, 1 wt % of a UV-photoinitiator (e.g. Irgacure 907, Ciba Geigy) is added into the mixed solution. Then, the mixed solution with 1 wt % of the UV-photoinitiator is coated on a polyester (PET) film which has undergone an alignment treatment, and the thickness of the PET film is 50 μm. Then, the mixed solution which is coated on the PET film is dried at 80 degrees Celsius for 2 minutes and then is irradiated by a 100 W/cm² UV light for 20 seconds to form a Cholesteric Liquid Crystal film with a thickness of about 8 μm.

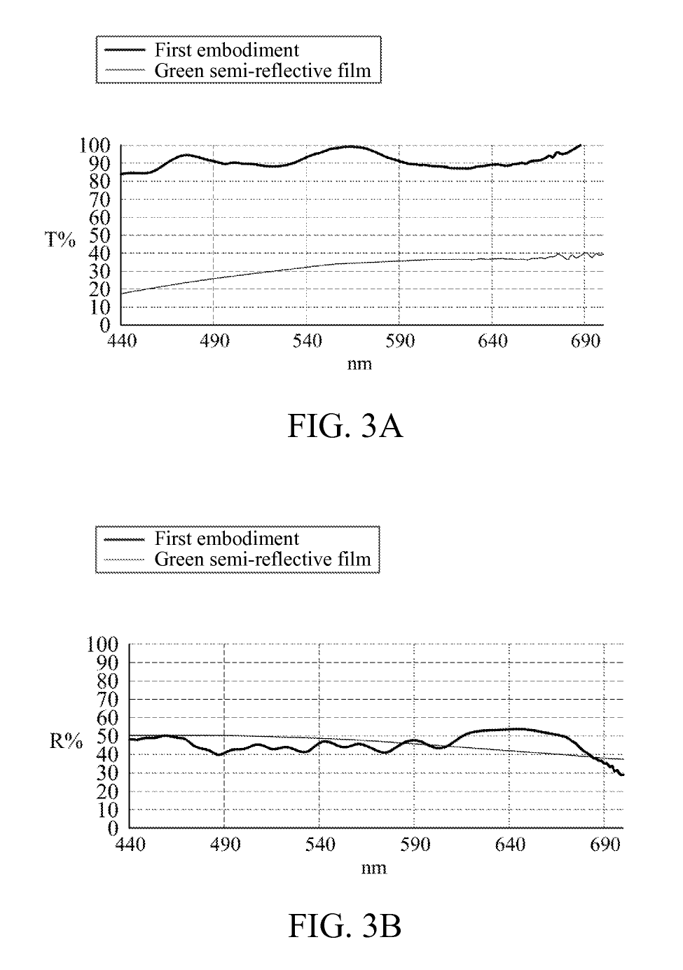

Please refer to FIGS. 3A and 3B. FIG. 3A is a chart of transmittances (T %) of a reflective optical film exposed to a plurality of light beams having different wavelengths (nm) according to the first embodiment of the disclosure. FIG. 3B is a chart of reflection rates (R %) of the reflective optical film exposed to the plurality of light beams having different wavelengths (nm) according to the first embodiment of the disclosure.

A fiber optical spectrometer, e.g., Ocean Optics No. USB4000-UV, is provided for measuring transmittances (T %) of the reflective optical film 10a and a conventional green semi-reflective film in the first embodiment. The transmittance of the reflective optical film 10a and the transmittance of conventional green semi-reflective film are measured under ambient light when the power of the display panel 20 is on. As shown in FIG. 3A, the transmittance (T %) of the conventional green semi-reflective film is about 32.3%. To the contrary, in the first embodiment, the transmittance (T %) of the reflective optical film 10a is about 92.9%.

A high-level ultraviolet-visible spectrophotometer, e.g., Perkin Elmer, No Lambda 900 is provided for measuring reflection rates (R %) of the reflective optical film 10a and the conventional green semi-reflective film in the first embodiment. The reflection rates (R %) of the reflective optical film 10a and the conventional green semi-reflective film are measured under ambient light when the power of the display panel 20 is on. As shown in FIG. 3B, the reflection rate (R %) of the conventional green semi-reflective film is about 46.1%. In the first embodiment, the reflection rate (R %) of the reflective optical film 10a is about 45.9%.

According to the results as described above, in the first embodiment, the reflection rate of the reflective optical film 10a is slightly lower than the reflection rate of the conventional green semi-reflective film when the power of the display panel 20 is on, thus an anti-glare effect of the reflective optical film 10a is better than the anti-glare effect of the conventional green semi-reflective film. In addition, in the first embodiment, the transmittance of the reflective optical film 10a capable of being pervious to light is higher than the transmittance of the conventional green semi-reflective film. Thus, the anti-glare effect of the reflective optical film 10a is much better than the anti-glare effect of the conventional green semi-reflective film. Consequently, the whole display quality of the display module 1 is improved.

Furthermore, in the first embodiment, when the power of the display panel 20 in the reflective optical film 10a is off, the parts of the linear polarized light and the circularly polarized light of the ambient light is reflected to provide mirror functions by the cholesteric liquid crystal layer 300. This increases the additional value when the power of the display module 1 is off.

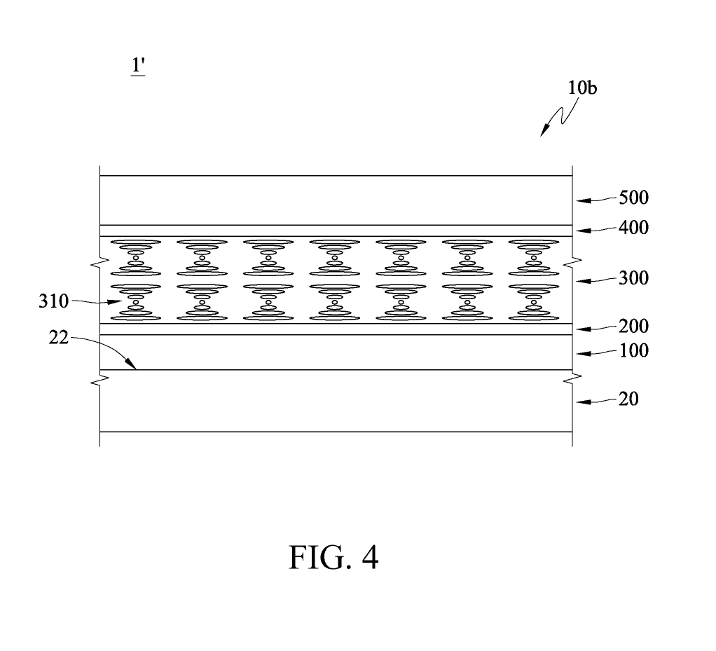

Please refer to FIG. 4, which is a schematic view of a display module according to a second embodiment of the disclosure. In the second embodiment, a display module 1′ includes a display panel 20 and a reflective optical film 10b. The display panel 20 has a display surface 22. The reflective optical film 10b includes a first anti-glare layer 100, a cholesteric liquid crystal layer 300 and a second anti-glare layer 500. The first anti-glare layer 100 is disposed between the display surface 22 of the display panel 20 and the cholesteric liquid crystal layer 300. The second anti-glare layer 500 is disposed on a surface of the cholesteric liquid crystal layer 300. The cholesteric liquid crystal layer 300 is disposed between the second anti-glare layer 500 and the first anti-glare layer 100. That is to say, the second anti-glare layer 500 and the first anti-glare layer 100 are opposite to each other.

In addition, the reflective optical film 10b further includes a first light transmission adhesive 200 and a second light transmission adhesive 400. The cholesteric liquid crystal layer 300 is attached to the first anti-glare layer 100 through the first light transmission adhesive 200. The second anti-glare layer 500 is attached to the cholesteric liquid crystal layer 300 through the second light transmission adhesive 400. Each of the first light transmission adhesive 200 and the second light transmission adhesive 400, is for example, an ultraviolet ray optical adhesive, e.g., CHEM-MAT, No. UV298. In addition, the first anti-glare layer 100 and the cholesteric liquid crystal layer 300 are similar to those described in the first embodiment and thus will not be further described.

The second anti-glare layer 500 has a plurality of moth-eye structures or periodically wave-shaped nanostructures disposed thereon. The second anti-glare layer 500 is, for example, a polyethylene terephthalate (PET) having a plurality conical protrusions (moth-eye structures). The conical protrusions are made of photocurable resin (photopolymer), as disclosed in the first embodiment.

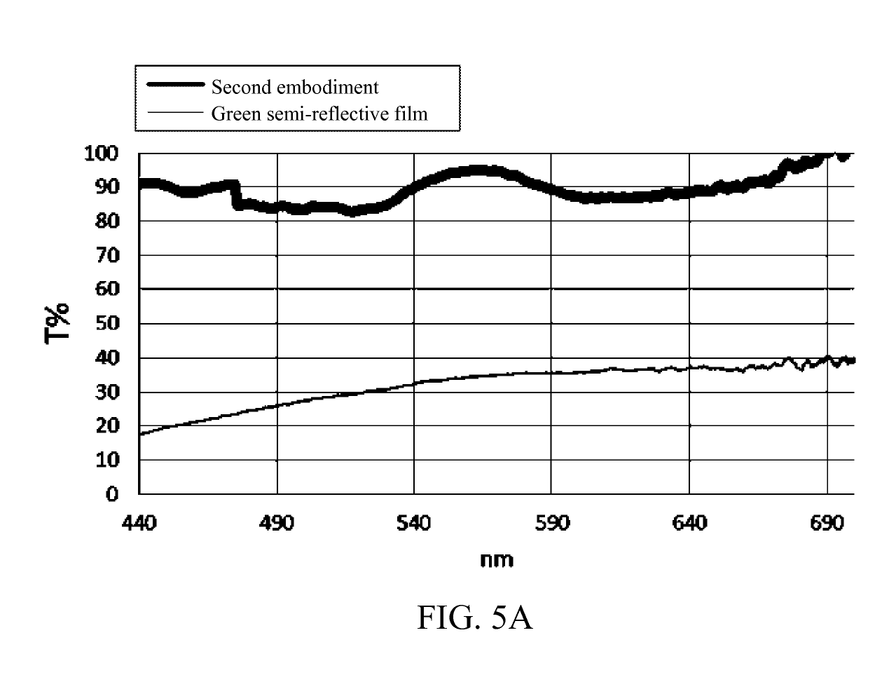

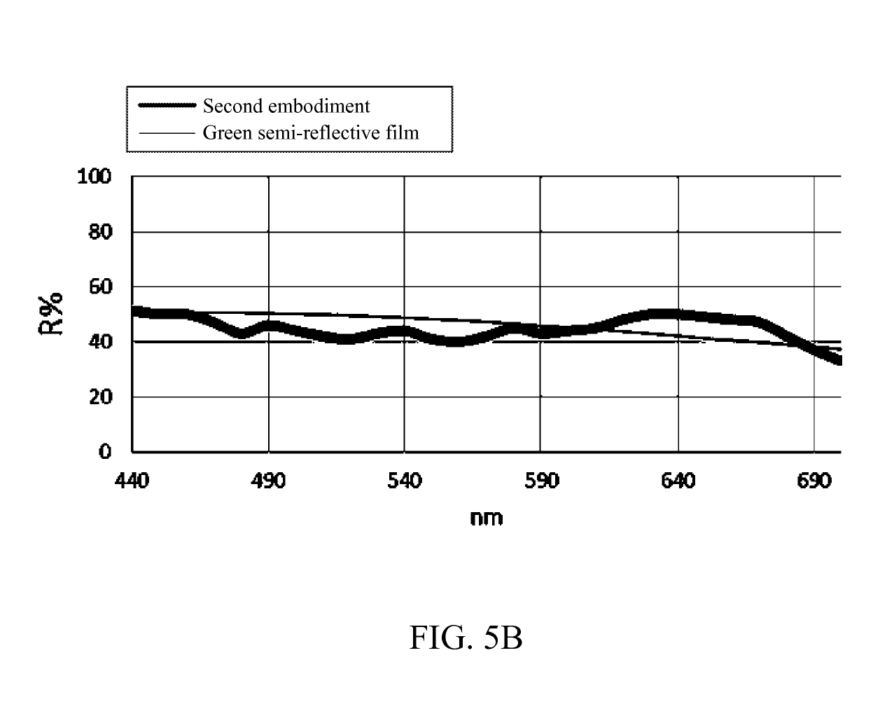

Please refer to FIGS. 5A and 5B. FIG. 5A is a chart of transmittances (T %) of a reflective optical film exposed to a plurality of light beams having different wavelengths (nm) according to the second embodiment of the disclosure. FIG. 5B is a chart of reflection rates (R %) of the reflective optical film exposed to the plurality of light beams having different wavelengths (nm) according to the second embodiment of the disclosure.

The fiber optical spectrometer USB4000-UV is provided for measuring transmittances (T %) of the reflective optical film 10b and a conventional green semi-reflective film in the second embodiment. The transmittances (T %) of the reflective optical film 10b and the transmittance of conventional green semi-reflective film are measured under ambient light when the power of the display panel 20 is on. As shown in FIG. 5A, the transmittance (T %) of the conventional green semi-reflective film is about 32.3%. To the contrary, in the second embodiment, the transmittance (T %) of the reflective optical film 10b is about 89.6%.

Then, the high-level ultraviolet-visible spectrophotometer Lambda 900 is provided for measuring reflection rates (R %) of the reflective optical film 10a and the conventional green semi-reflective film in the second embodiment. As shown in FIG. 5B, the reflection rate (R %) of the conventional green semi-reflective film is about 46.1%. In the second embodiment, the reflection rate (R %) of the reflective optical film 10b, which is capable of being pervious to light, is about 45.1%.

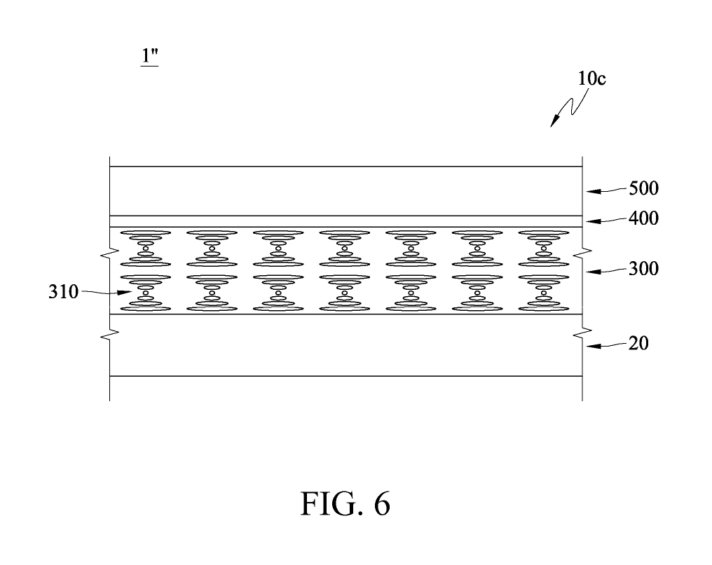

Please refer to FIG. 6, which is a schematic view of a display module according to a comparative group of the disclosure. A display module 1″ is provided in this comparative group. The display module 1″ includes a display panel 20 and a reflective optical film 10c which is capable of being pervious to light. The display panel 20 has a display surface 22. The reflective optical film 10c includes a second anti-glare layer 500 and a cholesteric liquid crystal layer 300. The cholesteric liquid crystal layer 300 is disposed between the display surface 22 of the display panel 20 and the second anti-glare layer 500. In addition, the reflective optical film 10c further includes a light transmission adhesive 400. The light transmission adhesive 400 is, for example, an ultraviolet ray optical adhesive, e.g., CHEM-MAT, No. UV298. In addition, the second anti-glare layer 500 and the cholesteric liquid crystal layer 300 are similar to those of the third embodiment and thus will not be further described.

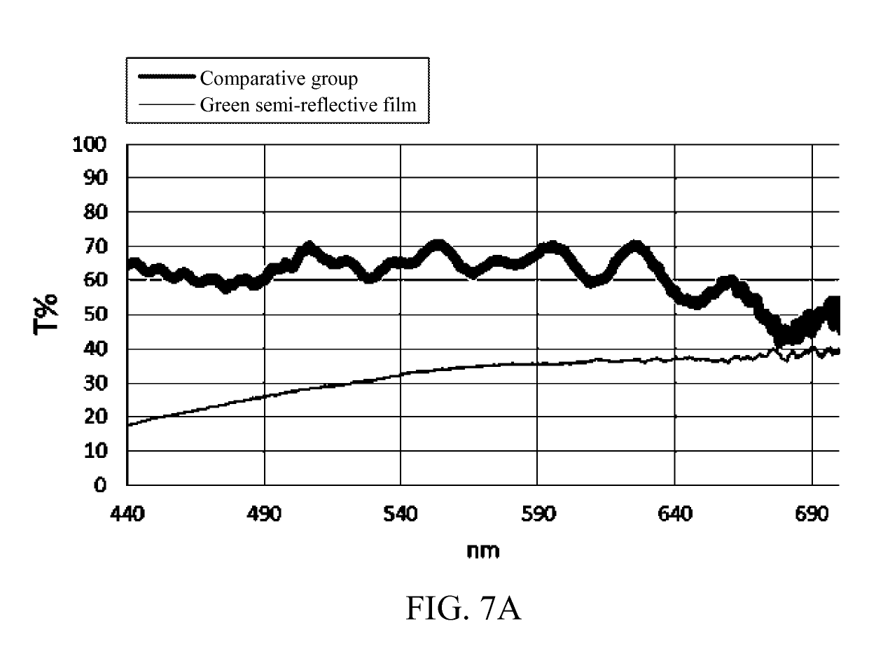

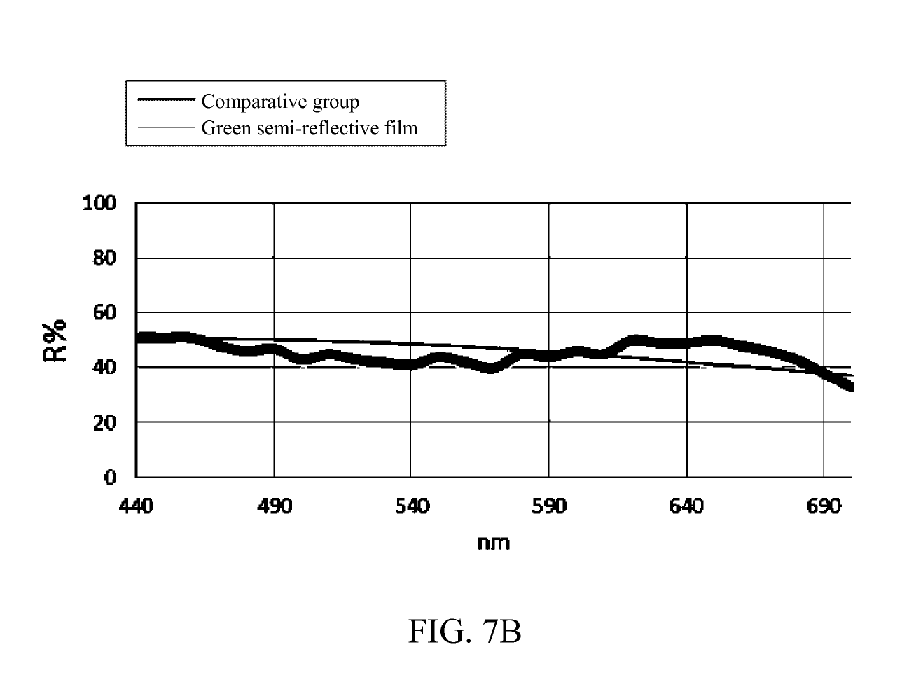

Please refer to FIGS. 7A and 7B. FIG. 7A a chart of transmittances (T %) of a reflective optical film exposed to a plurality of light beams having different wavelengths (nm) according to the comparative group of the disclosure. FIG. 7B is a chart of reflection rates (R %) of the reflective optical film exposed to the plurality of light beams having different wavelengths (nm) according to the comparative group of the disclosure. The transmittance (T %) of the reflective optical film 10c is about 61.3%, and the reflection rate (R %) of the reflective optical film 10c is about 45.6%.

What is claimed is:

1. A display module, comprising:
a display panel having a display surface; and
a reflective optical film disposed on the display surface of the display panel, and the reflective optical film comprising:
a cholesteric liquid crystal layer comprising a plurality of helical liquid crystal molecules; and
a first anti-glare layer disposed between the display surface of the display panel and the cholesteric liquid crystal layer.

2. The display module according to claim 1, wherein the reflective optical film further comprises a second anti-glare layer disposed on the cholesteric liquid crystal layer, and the cholesteric liquid crystal layer is disposed between the first anti-glare layer and the second anti-glare layer.

3. The display module according to claim 1, wherein the first anti-glare layer has a plurality of moth-eye structures.

4. The display module according to claim 2, wherein the second anti-glare layer has a plurality of moth-eye structures.

5. The display module according to claim 1, wherein the reflective optical film further comprises a first light transmission adhesive, and the cholesteric liquid crystal layer is attached to the first anti-glare layer through the first light transmission adhesive.

6. The display module according to claim 2, wherein the reflective optical film further comprises a second light transmission adhesive, and the cholesteric liquid crystal layer is attached to the second anti-glare layer through the second light transmission adhesive.

7. The display module according to claim 1, wherein the cholesteric liquid crystal layer has a reflection wavelength in a wavelength range between 400 nm and 700 nm.
